(19) United States
(12) Patent Application Publication
(10) Pub. No.: US 2009/0211958 A1
(43) Pub. Date: Aug. 27, 2009

(54) DOMESTIC AQUAPONIC RECREATION SYSTEM DARS2007

(76) Inventor: Thomas Edward Orsillo, Gloucester, MA (US)

Correspondence Address: Thomas Orsillo;DBA Gloucester Fish & Game, 14 Rockwood LA, Gloucester, MA, 01930, US

(21) Appl. No.: 11/684,791

(22) Filed: Feb. 26, 2008

(51) Int. Cl. A01K 63/04

(52) U.S. Cl. 210/167.22; 210/167.26

(57) ABSTRACT

The construct of DARS described by (FIG—A) which incorporates by reference all assemblies and sub assembly drawings outlined in the DARS master drawing list (FIG—1) will result in a portable recirculating aquaculture system or fish farm that will provide the user with the following capabilities;
A means by which to raise or store edible varieties of fish to a market-size.
A means by which to raise or store live ornamental or bait fish.
A means by which to raise or store live fish specimens used in research.
A means by which to deliver live fish to local markets.
A means by which to produce up to 200 liters of nutrient rich water to nourish hydroponic, aquaponic and terrestrial farm-plants.

DARS is a recirculating aquaculture system, a self-contained-fish-farm designed for light industrial use.

DARS is comprised of commercially available components carefully selected, assembled and tested to assure fidelity of performance at the lowest possible life-cycle cost to the end user.

### DESCRIPTION OF DRAWINGS

FIG. 1: List—Title and Nomenclature of Drawings.

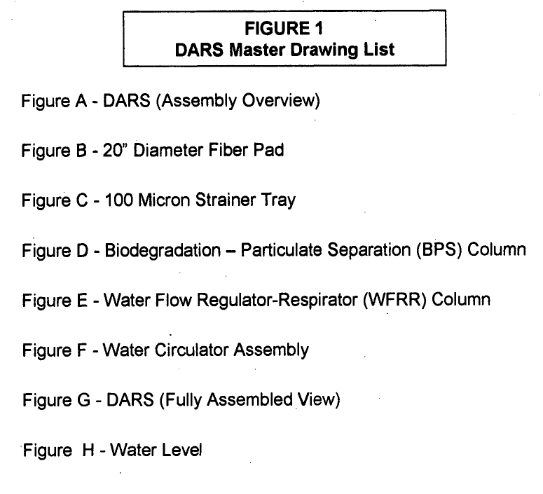

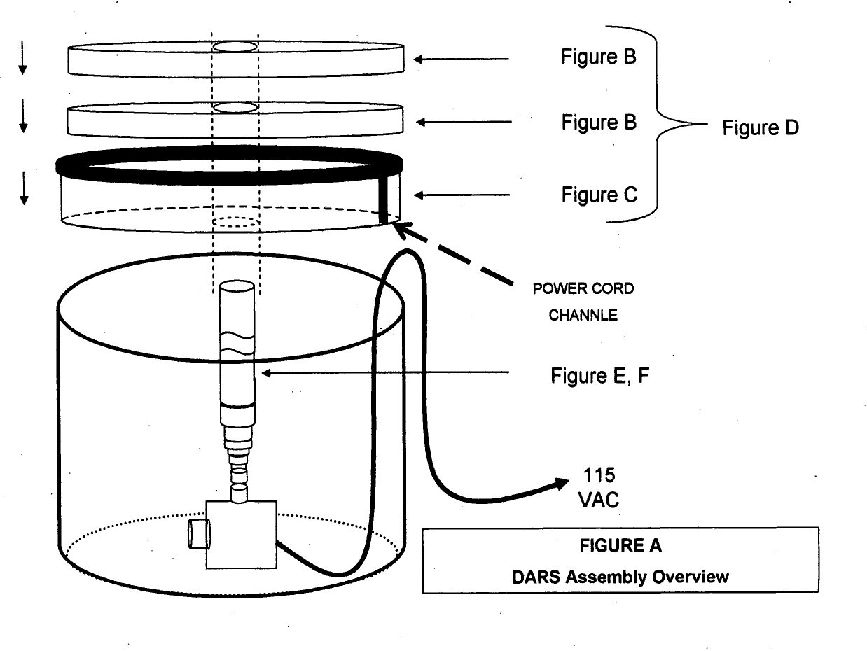

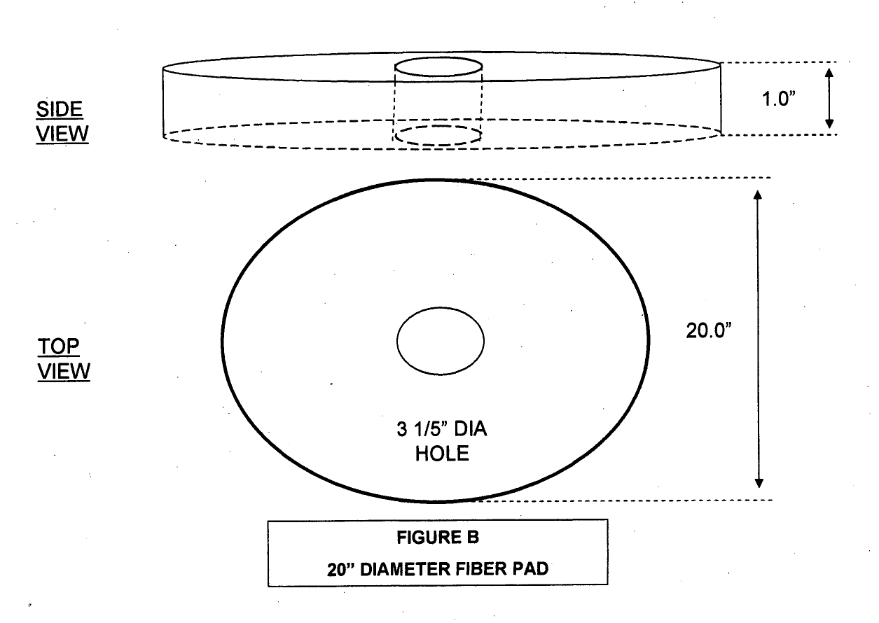

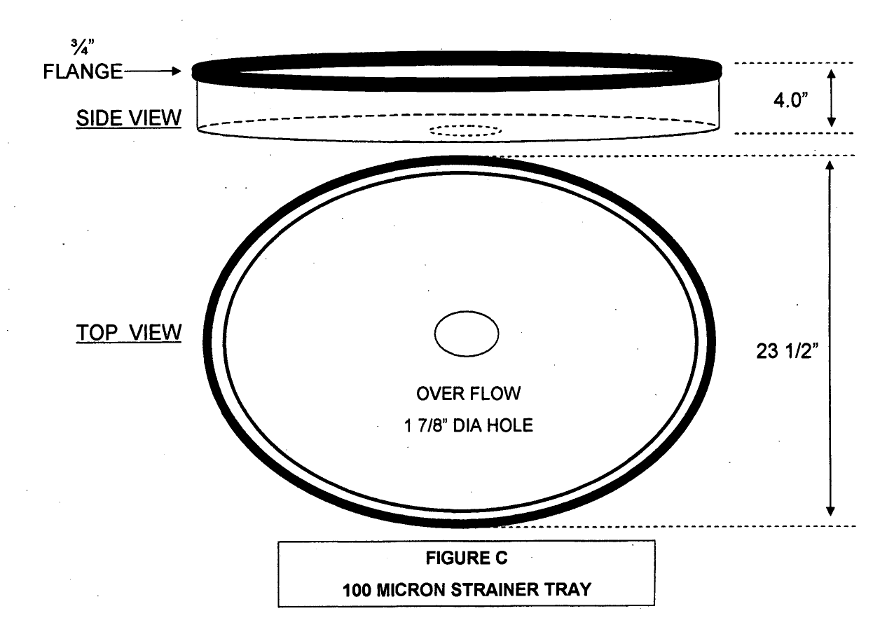

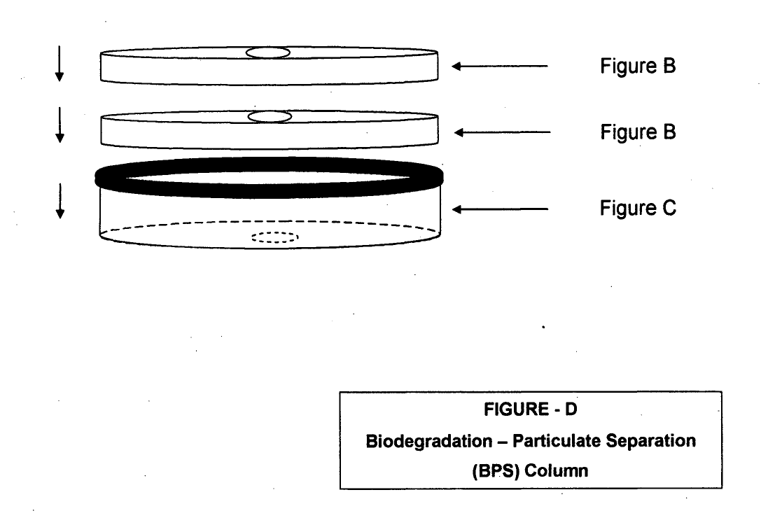

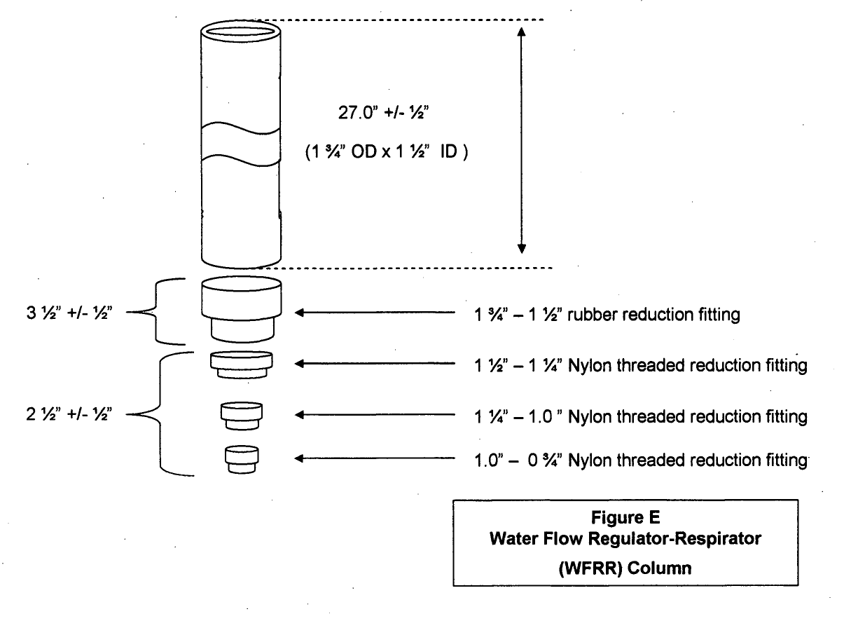

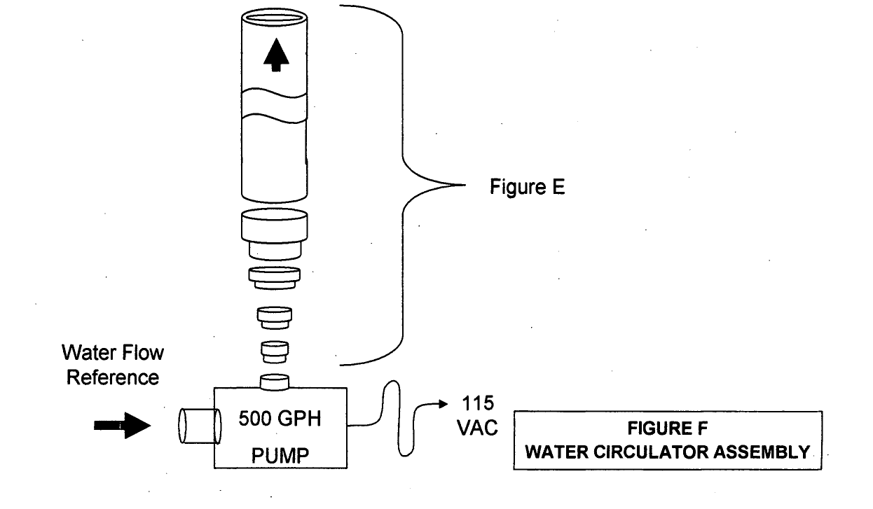

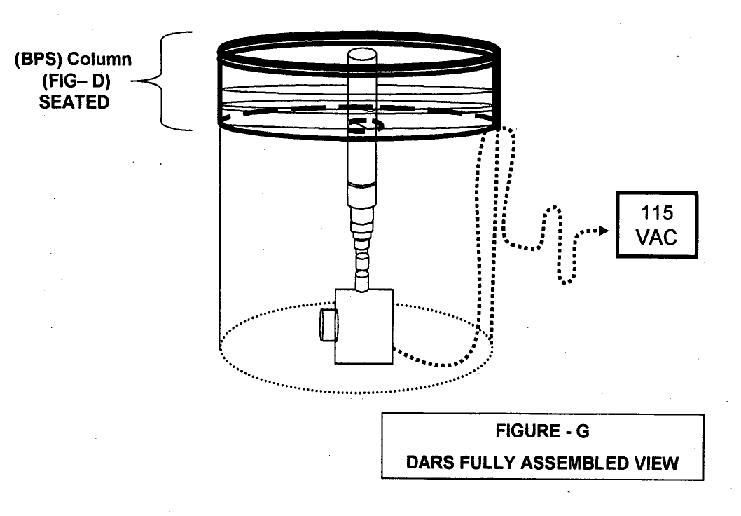

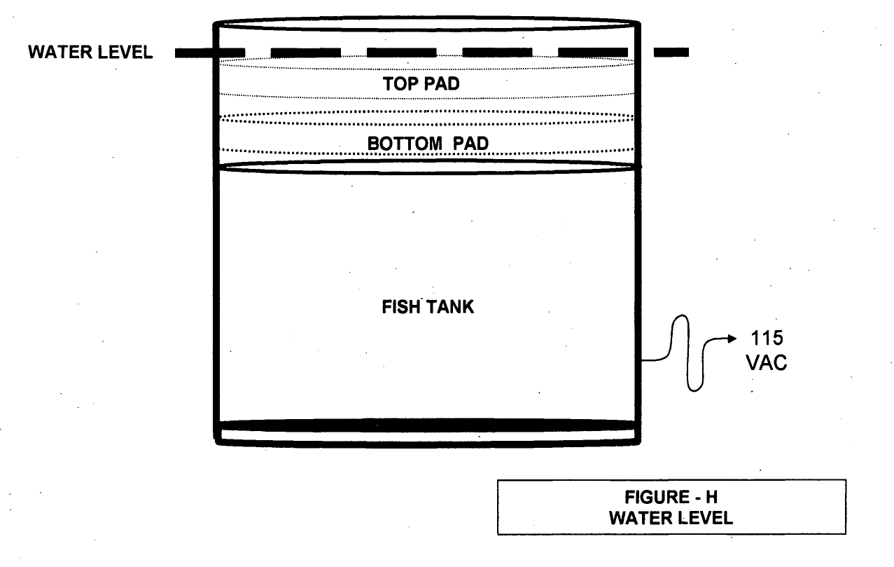

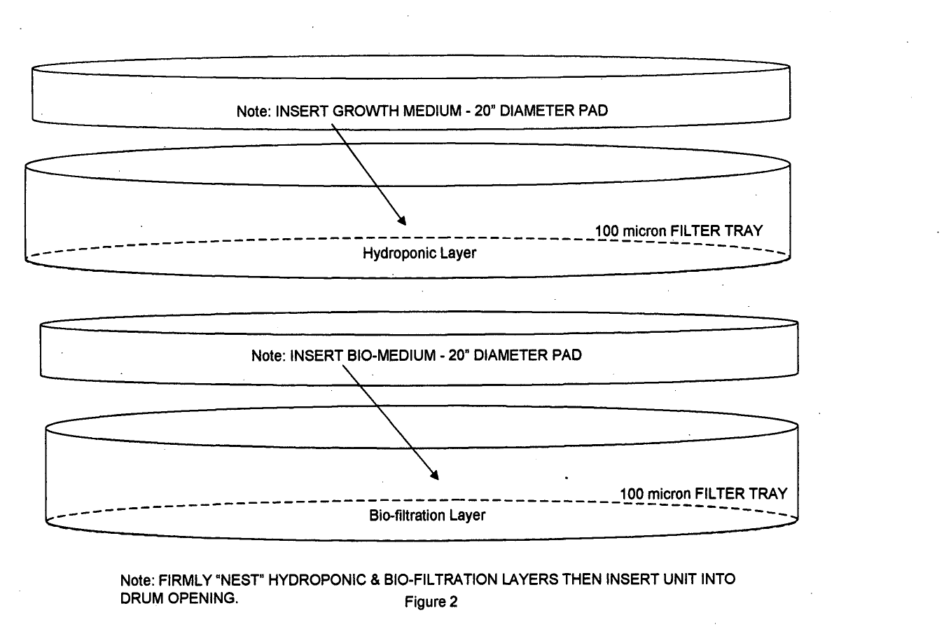

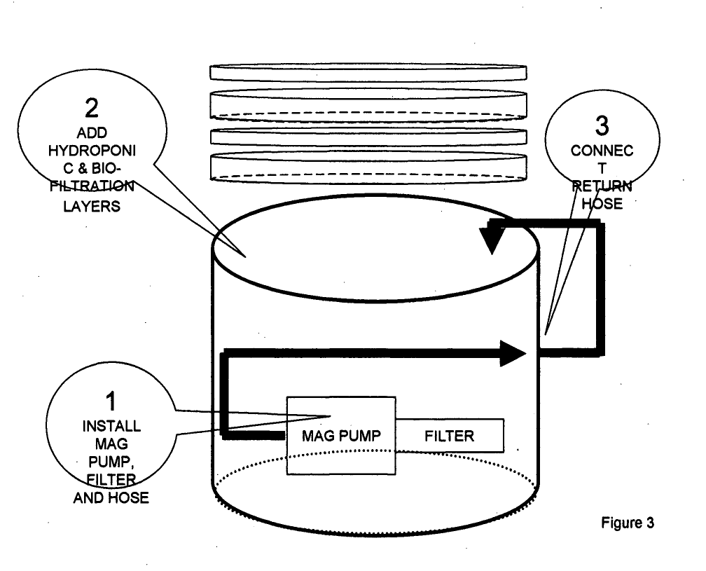

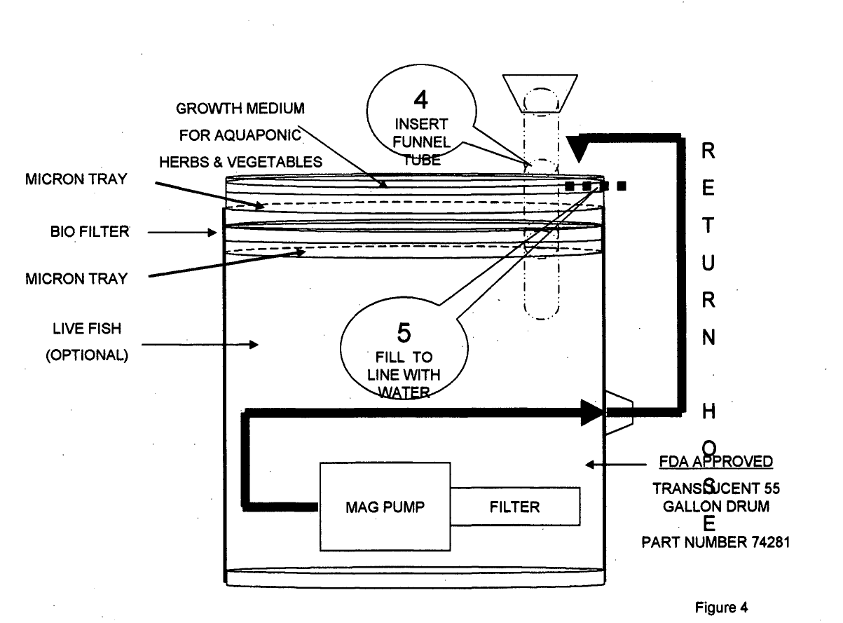

FIG. A: The Logical Order in Which the Invention is Assembled.

FIG. B: (Fiber Pad) Bio Filtration—Beneficial Microbe Growth Medium.

FIG. C: (100 Micron Strainer Tray) Particulate Water Filter.

FIG. D: (BPS) Biodegradation and Particulate Separator;

Note: (FIG—D) the BPS column results when we nest (FIGS. B & C) together. Water passing through the BPS is purified by resident microbes via a process called nitrification.

FIG. E: (WFRR) Water Flow Regulator-Respirator.

Note: (FIG—E) the WFRR column evenly distributes water across the surface of the BPS, (FIG—D) thereby facilitating nitrification.

FIG. F: Water Circulator Assembly Drawing.

Note: (FIG—F) is an illustration of (FIG—E) connected to the 500 GPH submersible pump used to circulate water throughout DARS.

FIG. G: is a reference drawing of DARS fully assembled.

FIG. H: is a reference drawing of the water level to be maintained in DARS.

How It Works:

The Water Flow Regulator-Respirator, WFRR column (FIG—E) aerates water rich in fish waste as it is pumped from the fish tank and delivered it to the Biodegradation—Particulate Separation, BPS column (FIG—D) at a rate of up to 500 GPH. As the water percolates downward through the layers of the BPS, particulate matter are captured.

As the water is gravity fed back to the fish tank it is further purified by resident colonies of beneficial microbes in a process called nitrification.

Making It:

Assemble DARS in accordance with (FIG—A).

Fill DARS (FIG—H) with good quality water to just above the surface of the (BPS) then release microbes into the water.

Note: The DARS operator has locally available pet shops from which to obtain these microbes.

Plug the DARS power cord into (115 VAC) outlet.

Allow DARS to cycle for 4 to 6 weeks in order to propagate adequate numbers of microbes in the BPS column before adding fish.

Note: always test water quality before adding or feeding fish in any recirculating aquaculture system.

Using DARS:

DARS may be used to raise or store edible varieties of fish (up to 50 at a time) to a market-size of approximately one pound per fish.

DARS may be used to raise or store live ornamental or bait fish.

DARS may be used to raise or store live fish specimens used in research.

Using an (AC/DC) mobile power adaptor DARS may be used to deliver live fish to local markets.

DARS may be used to produce nutrient rich water to nourish hydroponic and terrestrial farm-plants.

1. The BPS column is a subassembly of DARS and is comprised of two fiber pads nestled in a 100 micron strainer. The resulting BPS column is then firmly seated over the mouth of a 55 gallon open-head polyethylene fish tank. The biomass with in the BPS column converts ammonia to nitrite, and ultimately nitrate, through an oxidation process commonly referred to as nitrification. The BPS column also conveniently captures macroscopic particulate matter greater than 100 microns and holds it for later remove by the operator.

2. The WFRR column is a subassembly of DARS which evenly distributes water from its output tube thereby saturating the layers of the BPS column (FIG—D) and delivering essential nutrients to the biomass which in this case are the colonies of beneficial microbes that thrives with in each layer of the BPS. Another benefit of the WFRR design is its inherent respirator action. As the out-put-water-column collapses upon itself it creates a 360 degree water fall or cascade which gently splashes over the surface of the top layer of the bps column. This action captures, dissolves and mixes air with fish waste, enriching it with oxygen which is an essential element in the biodegradation or nitrification process.

3. The construct of DARS described by DARS master drawing list (FIG—1) in accordance with the assembly procedure outlined in (FIG—A) will result in a portable recirculation aquaculture system or fish farm that will provide the user with the following capabilities;
Raise or Store Edible Varieties of Fish to a Market-Size.
Raise or Store Live Ornamental or Bait Fish.
Raise or Store Live Fish Specimens Used in Research.
A Means by Which to Deliver Live Fish to Local Markets.
Produce Nutrient Rich Water to Norrish Hydroponic, Aqauponic and Terrestrial Farm-Plants
